(19) United States
(12) Patent Application Publication
(10) Pub. No.: US 2026/0012863 A1
(43) Pub. Date: Jan. 8, 2026

(54) PERFORMING A POWER RAMPING AND LTM CELL SWITCH EXECUTION IN A COMMUNICATION SYSTEM

(71) Applicant: Samsung Electronics Co., Ltd., Suwon-si (KR)

(72) Inventor: Aby Kanneath ABRAHAM, Bengaluru (IN)

(21) Appl. No.: 19/261,213

(22) Filed: Jul. 7, 2025

(30) Foreign Application Priority Data
Jul. 8, 2024 (IN) 202441052284
Dec. 19, 2024 (IN) 202441100747
Jun. 23, 2025 (IN) 2024 41052284

(51) Int. Cl. H04W 36/04; H04W 36/00; H04W 74/0833; H04W 76/20

(52) U.S. Cl. CPC H04W 36/04; H04W 36/0069; H04W 74/0833; H04W 76/20

(57) ABSTRACT

The disclosure relates to a 5G or 6G communication system for supporting a higher data transmission rate. Embodiments herein provide a method and system for performing a power ramping for early timing advance synchronization in a communication system.

### CROSS-REFERENCE TO RELATED APPLICATION(S)

This application is based on and claims priority under 35 U.S.C. § 119 (a) of an Indian Provisional patent application No. 202441052284, filed on Jul. 8, 2024, in the Indian Patent Office, of an Indian Provisional patent application No. 202441100747, filed on Dec. 19, 2024, in the Indian Patent Office, and of an Indian Complete patent application No. 202441052284, filed on Jun. 23, 2025, in the Indian Patent Office, the disclosure of each of which is incorporated by reference herein in its entirety.

### BACKGROUND

### 1. Field

The disclosure relates to the field of wireless communication. More particularly, the disclosure relates to a method and system for performing a power ramping for early timing advance synchronization and a layer 1 (L1)/layer 2 (L2) Triggered Mobility (LTM) cell switch execution in a communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer (PHY) standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for performing a power ramping for early timing advance synchronization and an LTM cell switch execution in a communication system.

Another aspect of the disclosure is to retain the same preamble power ramping counter when the random access procedure is initiated by the physical downlink control channel (PDCCH) order for an LTM candidate cell in a different cell group.

Another aspect of the disclosure is to share the status of the PDCCH order reception with the UE medium access control (MAC) entities.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes applying a radio resource control (RRC) reconfiguration due to a layer 1/layer 2 triggered mobility (LTM) cell switch execution, determining whether the RRC reconfiguration due to the LTM cell switch execution is configured via an LTM configuration (LTM-config) information element (IE) contained in new radio secondary cell group (nr-SCG) IE within a multi radio dual connectivity secondary cell group (mrdc-SecondaryCellGroup) IE, and in case that the RRC reconfiguration due to the LTM cell switch execution is configured via the LTM-config contained in the nr-SCG within the mrdc-SecondaryCellGroup, transmitting, to a base station, an RRC reconfiguration complete message via a signaling radio bearer (SRB1) embedded in NR RRC message uplink information transfer MRDC (ULInformation TransferMRDC).

In accordance with another aspect of the disclosure, a method performed by a base station in a wireless communication system is provided. The method includes transmitting, to a terminal, a radio resource control (RRC) reconfiguration message comprising configuration information on a layer 1/layer 2 triggered mobility (LTM) cell switch execution, and in case that the RRC reconfiguration message is applied due to the LTM cell switch execution and is configured via an LTM configuration (LTM-config) information element (IE) contained in new radio secondary cell group (nr-SCG) IE within a multi radio dual connectivity secondary cell group (mrdc-SecondaryCellGroup) IE, receiving, from the terminal, an RRC reconfiguration complete message via a signaling radio bearer (SRB1) embedded in NR RRC message uplink information transfer MRDC (ULInformationTransferMRDC).

In accordance with another aspect of the disclosure, a method for performing an LTM cell switch execution in a communication system is provided. The method includes generating a RRC reconfiguration message for an intra-SN LTM candidate cell. Further, the method includes transmitting the RRC reconfiguration message via the SRB1 within the NR-SCG to a UE. Further, the method includes receiving a RRC reconfiguration complete message via the SRB1 embedded in a NR RRC in an UL information transfer MRDC from the UE, when the RRC reconfiguration message is applied due to the LTM cell switch execution configured via the LTM configuration received via the SRB1 included in a MRDC-SCG configuration.

In accordance with another aspect of the disclosure, a terminal in a wireless communication system is provided. The terminal includes a transceiver, and a controller coupled with the transceiver and configured to apply a radio resource control (RRC) reconfiguration due to a layer 1/layer 2 triggered mobility (LTM) cell switch execution, determine whether the RRC reconfiguration due to the LTM cell switch execution is configured via an LTM configuration (LTM-config) information element (IE) contained in new radio secondary cell group (nr-SCG) IE within a multi radio dual connectivity secondary cell group (mrdc-SecondaryCellGroup) IE, and in case that the RRC reconfiguration due to the LTM cell switch execution is configured via the LTM-config contained in the nr-SCG within the mrdc-SecondaryCellGroup, transmit, to a base station, an RRC reconfiguration complete message via a signaling radio bearer (SRB1) embedded in NR RRC message uplink information transfer MRDC (ULInformationTransferMRDC).

In accordance with another aspect of the disclosure, a base station in a wireless communication system is provided. The base station includes a transceiver, and a controller coupled with the transceiver and configured to transmit, to a terminal, a radio resource control (RRC) reconfiguration message comprising configuration information on a layer 1/layer 2 triggered mobility (LTM) cell switch execution, and in case that the RRC reconfiguration message is applied due to the LTM cell switch execution and is configured via an LTM configuration (LTM-config) information element (IE) contained in new radio secondary cell group (nr-SCG) IE within a multi radio dual connectivity secondary cell group (mrdc-SecondaryCellGroup) IE, receive, from the terminal, an RRC reconfiguration complete message via a signaling radio bearer (SRB1) embedded in NR RRC message uplink information transfer MRDC (ULInformationTransferMRDC).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

The embodiments provide a method and system for performing a power ramping for early timing advance synchronization and an LTM cell switch execution in a communication system.

Other embodiments retain the same preamble power ramping counter when the random access procedure is initiated by the PDCCH order for an LTM candidate cell in a different cell group.

Yet other embodiments share the status of the PDCCH order reception with the UE MAC entities.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram that illustrates an architecture of a next generation radio access network (NG-RAN) according to the related art;

FIG. 2 is a block diagram that illustrates a NR radio protocol stack architecture for a user plane according to the related art;

FIG. 3 is a block diagram that illustrates a NR radio protocol stack architecture for a control plane according to the related art;

FIG. 4 is a schematic diagram that illustrates an overview of a medium access control (MAC) structure according to the related art;

FIG. 5 is a schematic diagram that illustrates the MAC structure overview with two MAC entities according to the related art;

FIG. 6 is a schematic diagram that illustrates a schematic of a UE implemented to carry out the disclosed subject matter according to an embodiment of the disclosure;

FIG. 7 is a schematic diagram that illustrates a schematic of a network apparatus implemented to carry out the disclosed subject matter according to an embodiment of the disclosure;

FIG. 8 is a flow diagram that illustrates a method for performing a power ramping for early timing advance synchronization in a communication system according to an embodiment of the disclosure;

FIG. 9 is a flow diagram that illustrates a method for performing an LTM cell switch execution in a communication system according to an embodiment of the disclosure;

FIG. 10 is a flow diagram that illustrates a method for performing an LTM cell switch execution in a communication system by the UE according to an embodiment of the disclosure;

FIG. 11 is a flow diagram that illustrates a method for generating a RRC reconfiguration complete message based on an LTM cell switch execution configuration according to an embodiment of the disclosure; and

FIG. 12 is a flow diagram that illustrates a method for performing an LTM cell switch execution in a communication system by the network apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Particular terms as used in the following description are merely provided to help understanding of the disclosure, and other types of terms may be used without departing from the scope of the technical idea of the disclosure.

As used herein, terms referring to network entities, terms referring to messages, terms referring to identification information, and the like are illustratively used for the sake of descriptive convenience. Therefore, the disclosure is not limited by the terms as described below, and other terms referring to subjects having equivalent technical meanings may also be used.

In the following description, the disclosure will be described using terms and names defined in the 5G system standards for the sake of descriptive convenience, but the disclosure is not limited by these terms and names and may be applied in the same way to systems that conform other standards.

Power ramping is an essential approach in wireless communication networks that controls mobile device transmission power levels during initial link construction or handover procedures, hence facilitating the efficient and dependable formation of connections. The main purpose of power ramping is to manage the transmission power levels of mobile devices when they are initially trying to establish a connection with a base station (for example, eNodeB in long term evolution (LTE) or gNB in 5G New Radio). It helps in optimizing the process of establishing a reliable and stable communication link while minimizing interference and power consumption.

Currently, if the user equipment (UE) receives a physical downlink control channel (PDCCH) order for an L1/L2 Triggered Mobility (LTM) candidate cell for a master cell group (MCG) and the UE receives a PDCCH order on a secondary cell group (SCG), or vice-versa, the power ramping needs to be reset. This will incur complex interaction between the medium access control (MAC) entities of the MCG and SCG. The issue gets more complex in the network side, as the MAC entities for MCG and SCG are residing on two different nodes and their interaction is particularly complex due to the transport path in between them.

Further, in the rapidly evolving landscape of wireless communication technologies, efficient and seamless mobility management is crucial for ensuring uninterrupted service and optimal user experience, particularly in advanced systems like 5G New Radio (NR). Mobility management enables the UE to transition between different cells as they move, ensuring continuous connectivity. Traditionally, mobility in 5G NR has been managed through procedures like cell reselection in RRC_IDLE mode and handover in RRC_CONNECTED mode. These procedures, while effective, are not without their challenges.

In RRC_CONNECTED mode, network-controlled mobility is facilitated by a handover process that involves explicit radio resource control (RRC) signaling triggered by the next-generation Node B (gNB). The handover process generally comprises three main steps: preparation, execution, and completion. During this process, the gNB may configure the UE to report measurements, based on which, or on its own understanding of the network topology, it sends an RRC Reconfiguration message to effectuate the handover to a target cell. The UE then accesses the target cell and sends an RRC Reconfiguration complete message.

An alternative method introduced in third generation partnership project (3GPP) NR Release 16 allows the gNB to configure the UE with execution conditions for triggering handover autonomously. Once these conditions are satisfied, the UE can move to the target cell and send the RRC Reconfiguration complete message. Additionally, Release 16 introduced the dual active protocol stack (DAPS) handover, further diversifying handover methodologies. Despite these advancements, all these methods involve the UE performing handover by sending layer 3 (L3) (RRC) messages, which can lead to significant signaling overhead and latency issues. These are collectively referred to as layer 3 mobility.

In the context of dual connectivity, the UE may perform PSCellChange or Conditional PSCellChange, which are also categorized under layer 3 mobility. Specifically, PSCellChange or Conditional PSCellChange are considered SCG layer 3 mobility, whereas handover and Conditional Handover are regarded as MCG layer 3 mobility.

To address the challenges of signaling overhead and latency inherent in layer 3 mobility, the 3GPP Release 18 is exploring Lower Layers (L1/L2) Triggered Mobility (LTM). The objective of the LTM is to facilitate serving cell changes using L1/L2 signaling, thereby reducing latency, overhead, and interruption time. The gNB may configure the UE with multiple candidate cells to enable rapid application of configurations for these cells, and may send MAC Control Elements (CE) or L1 signaling to dynamically switch the UE from a source cell to a candidate cell. LTM can also be triggered based on the L1 measurements instead of the L3 measurements.

However, the current mechanisms present a significant drawback when a UE configured with both intra-Secondary Node (SN) LTM and inter-SN LTM simultaneously, executes an LTM cell switch. There is a lack of clarity on how the UE should communicate the complete message for SCG during the LTM cell switch, particularly how it should send the SCG RRCReconfigurationComplete message to the network. This ambiguity poses a challenge in ensuring seamless and efficient mobility, highlighting the need for further refinement and standardization in mobility management procedures.

Hence, is desirable to address the above mentioned problems and disadvantages or at least provide a useful alternative.

Dual connectivity or more technically multi-radio dual connectivity is specified by 3gpp in specifications such as TS 37.340. A summary of the details on dual connectivity is given below.

NG-RAN supports Multi-Radio Dual Connectivity (MR-DC) operation whereby the UE in RRC_CONNECTED is configured to utilize radio resources provided by two distinct schedulers, located in two different NG-RAN nodes connected via a non-ideal backhaul, one providing New Radio (NR) access and the other one providing either Evolved UMTS Terrestrial Radio Access (E-UTRA) or NR access. One node acts as the master node (MN) and the other as the secondary node (SN). The MN and SN are connected via a network interface and at least the MN is connected to the core network. NG-RAN supports NG-RAN E-UTRA-NR Dual Connectivity (NGEN-DC), in which a UE is connected to one ng-eNB (an E-UTRA base station that can connect to 5G core) that acts as a MN and one gNb (5G base station) that acts as a SN. The NG-RAN also supports NR-E-UTRA Dual Connectivity (NE-DC), in which a UE is connected to one gNB that acts as a MN and one ng-eNB that acts as a SN. Dual connectivity could be applicable for other Radio Access Technologies.

In wireless technologies like 5G NR, devices can move across different cells. The mobility is performed using a procedure called cell reselection in RRC_IDLE mode. Till NR R17, mobility is performed using a procedure called handover in RRC_CONNECTED mode. The network controlled mobility applies to UEs in RRC_CONNECTED. It requires explicit RRC signaling to be triggered by the gNB in NR. Handover in NR usually consists of three steps: handover preparation, handover execution and handover completion. The gNB may configure the UE to report measurements and based on the reported measurements or based on its own understanding of the network topology, the gNB will send RRC Reconfiguration message to handover the UE to another cell called target cell from the source cell. The UE accesses the target cell and sends RRC Reconfiguration complete message.

In an alternative way introduced in 3gpp NR release 16, the gNB may configure the UE with the execution conditions for triggering handover and once the execution conditions are satisfied, the UE may move to target cell and send the RRC Reconfiguration complete. 3gpp also introduced a new handover called DAPS handover in release 16. In all these methods, the UE performs handover by sending layer 3 (RRC) messages which causes considerable signaling overhead and latency issues. We can refer to the handover, and conditional handover (CHO) as layer 3 mobility. In case of dual connectivity, UE may perform PSCellChange or Conditional PSCellChange. In the context of dual connectivity, we can refer PSCellChange or Conditional PSCellChange also as layer 3 mobility. I.e. Handover, Conditional Handover, PSCellChange, Conditional PSCellChange etc. refers to L3 mobility. We can also refer PSCellChange or Conditional PSCellChange as SCG layer 3 mobility and the handover and CHO as MCG layer 3 mobility in the context of dual connectivity.

Further, the UE may receive RRC configuration for updating some of the security parameters. Some of the 3gpp specifications such as TS38.300, TS38.331, and TS 38.321 V17.2.0 are considered as background.

3gpp release 18 is considering Lower Layers (L1/L2 layers) Triggered Mobility, also known as LTM to solve the problem related to latency, signaling overhead etc. associated with layer 3 mobility. As per 3gpp, the goal of LTM is to enable a serving cell change via L1/L2 signaling, in order to reduce the latency, overhead and interruption time. The network (gNB) may configure the UE with multiple candidate cells to allow fast application of configurations for candidate cells. The network may further send MAC CE or L1 signaling to dynamically switch the UE from a source cell to one of the configured candidate cells. Further, the LTM can be triggered based on L1 measurements rather than L3 measurements.

3gpp proposes to perform LTM, without reset of lower layers like MAC to avoid data loss and to reduce the additional delay of data recovery wherever it is possible. The gNB CU may provide LTMCandidateConfiguration, i.e. configure LTM candidate cells through one RRCReconfiguration message for a candidate target cell. The gNB may further release or modify the candidate configurations. The UE may store the LTM configuration of other candidate cells even after moving to a candidate cell through LTM. The gNB CU also may provide the UE with configuration for performing LTM measurements for different candidate frequencies and candidate cells and reporting based on the performed LTM measurements.

The UE performs the L1 measurements on the source cell and candidate cell and report L1 measurements through CSI reports to the gNB DU of the source cell. The gNB DU may send a MAC CE (for e.g. LTM MAC CE or cell switch MAC CE) asking the UE to switch to another cell which is an LTM candidate cell. The UE may perform random access during LTM cell switch, or the cell switch may be a random access channel (RACH) less. The LTM may be performed based on L3 measurements also.

The UE may be requested to perform random access on a candidate cell before the cell switch, so that the network can calculate the timing advance before the cell switch and inform the UE either through a random access response or within the MAC CE which is send for the cell switch. The gNB may request the UE to perform random access towards one or more LTM candidate cells for receiving the timing advance (TA) before the cell switch is performed through signaling such as PDCCH order. This TA may be referred to as Early TA or Early Sync TA or TA for Early Sync. Random access performed on LTM candidate cells for the timing advance reception is known as random access for early TA. In our disclosure, we also refer random access performed on LTM candidate cells for the timing advance reception as early TA sync. A single random access procedure may be used for performing the early TA sync after receiving PDCCH order.

The UE receives PDCCH order from the primary cell (PCell)/primary secondary cell (PSCell) for early TA sync. Upon reception of this PDCCH order, the UE initiates RACH for TA measurement for candidate cells on the one or more candidate cell as indicated by the network. The UE sends RACH preamble to the candidate cells and may receive the LTM Cell switch command including the timing advance. If source DU indicates the UE to retransmit the RACH for early TA, UE retransmits the same. The gNB may send PDCCH order requesting the UE to retransmit random access preamble for TA measurement to one or more candidate cells. The UE increases the preamble power (performs power ramping) while retransmitting the random access preamble. Power ramping is done based on UE MAC variables such as PREAMBLE_POWER_RAMPING_COUNTER and PREAMBLE_POWER_RAMPING_STEP. For a preamble transmission, power ramping may be calculated as (PREAMBLE_POWER_RAMPING_COUNTER−1)×PREAMBLE_POWER_RAMPING_STEP.

Early sync may be used for other types of mobility such as L3 mobility. The UE may receive a PDCCH order for early TA sync, even when LTM is not configured.

UE RRC receives the configuration for early TA from gNB RRC. UE RRC configures UE MAC and/or UE L1 with the RACH configuration for early TA.

Interaction of PDCCH order for early TA and other PDCCH orders: If the UE receives PDCCH order for an LTM candidate cell and the previous random access preamble transmission was for any other cell, UE resets preamble power ramping counter. This is shown as below from TS 38.321.

If the Random Access procedure is initiated by the PDCCH order for an LTM candidate cell, which is different from the cell to which the UE performed the last Random Access Preamble transmission, and the PDCCH order indicates preamble re-transmission:
2> set the PREAMBLE_POWER_RAMPING_COUNTER to 1;

An issue with the current behavior is that it makes the UE and network implementation of early synchronization very complex. Some of the 3gpp specifications such as TS38.300, TS38.331, TS 38.321, TS 37.340 V18.1.0 and the CRs on these versions are considered.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

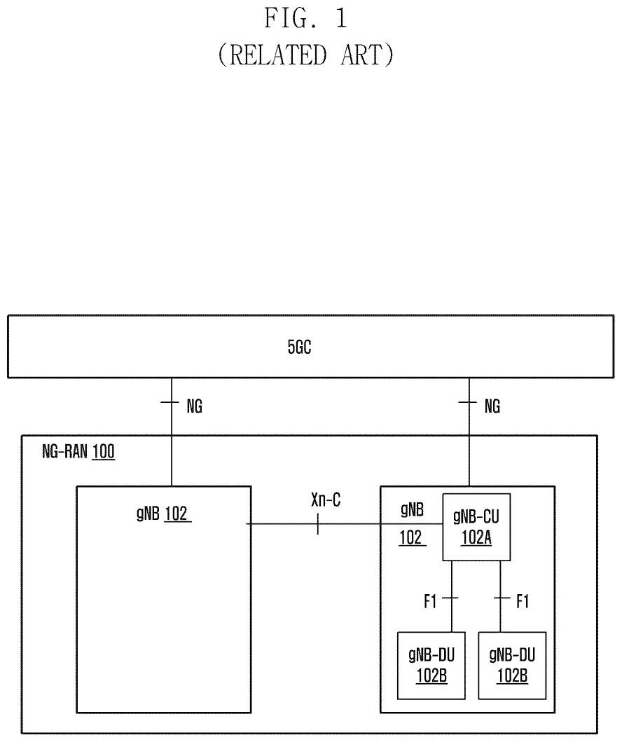

FIG. 1 is a block diagram that illustrates an architecture of an NG-RAN 100 according to the related art.

Referring to FIG. 1, the NG-RAN 100 includes of a gNB 102 or a set of gNBs connected to the 5GC through the NG interface. The gNB 102 can be interconnected through the Xn interface. The gNB 102 may include of a gNB-CU 102A and one or more gNB-DU(s) 102B. The gNB-CU 102A and the one of more gNB-DU(s) 102B is connected via F1 interface.

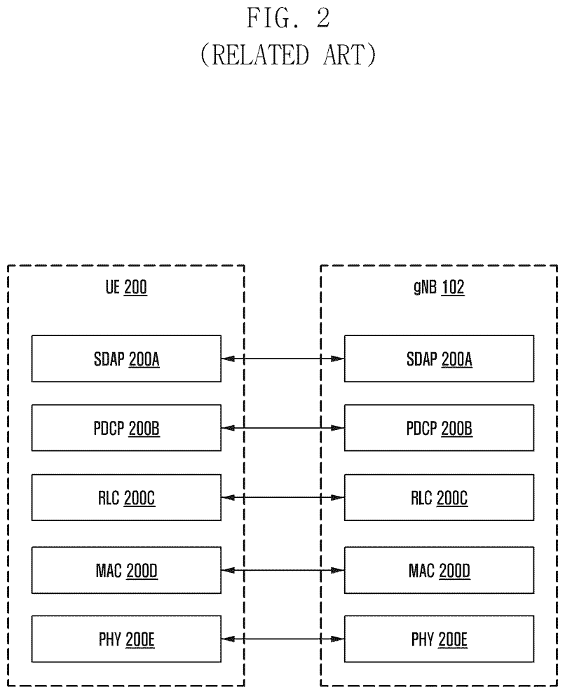

FIG. 2 is a block diagram that illustrates a NR radio protocol stack architecture for a user plane according to the related art.

Referring to FIG. 2, the NR radio protocol stack architecture shows a UE 200 in communication with the gNB 102. The UE 200 includes a service data adaption protocol (SDAP) 200A, a packet data convergence protocol (PDCP) 200B, a radio link control (RLC) 200C, a medium access control (MAC) 200D, and a physical layer (PHY) 200E sublayers. The gNB 102 also includes the SDAP 200A, the PDCP 200B, the RLC 200C, the MAC 200D, and the PHY 200E sublayers. The user plane protocol stack ensures smooth communication between the UE 200 and the gNB 102, optimizing data transfer and reliability. FIG. 2 shows the termination of the SDAP 200A, the PDCP 200B, the RLC 200C and the MAC 200D sublayers in the gNB 102 on the network side and in the UE 200.

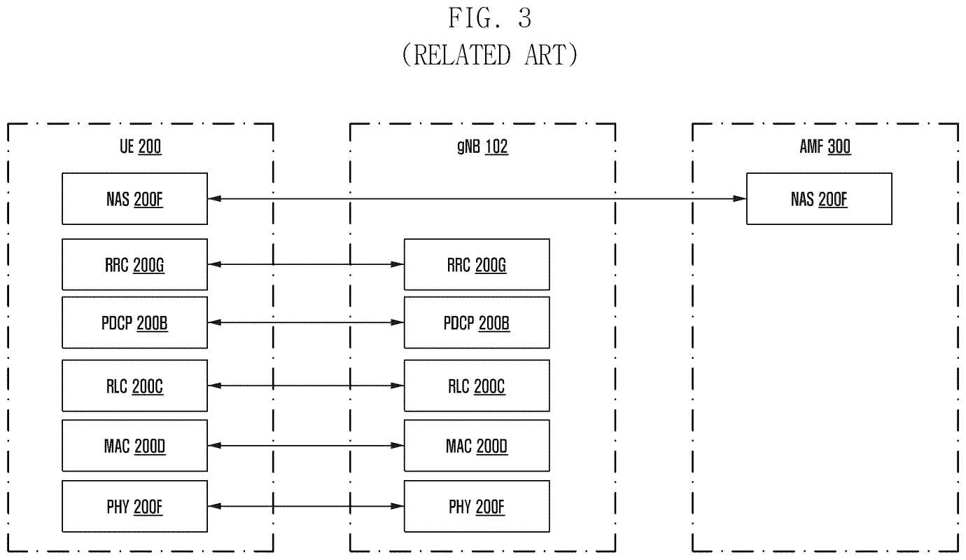

FIG. 3 is a block diagram that illustrates a NR radio protocol stack architecture for a control plane according to the related art.

Referring to FIG. 3, the NR radio protocol stack architecture includes the UE 200, the gNB 102, and an access and mobility management (AMF) 300 in communication with each other. The UE 200 includes a non-access stratum (NAS) 200F, a RRC 200G, the PDCP 200B, the RLC 200C, and MAC 200D, and the PHY 200E sublayers. The gNB 102 includes the RRC 200G, the PDCP 200B, the RLC 200C, and MAC 200D, and the PHY 200E sublayers. Further, the AMF 300 includes the NAS 200F sublayer.

The PDCP 200B, the RLC 200C, and the MAC 200D sublayers (terminated in the gNB 102 on the network side) perform the user plane functions. The RRC 200G (terminated in the gNB 102 on the network side) performs the functions for control plane. The NAS 200F control protocol (terminated in the AMF 300 on the network side) performs functions like authentication, mobility management, security control and the like.

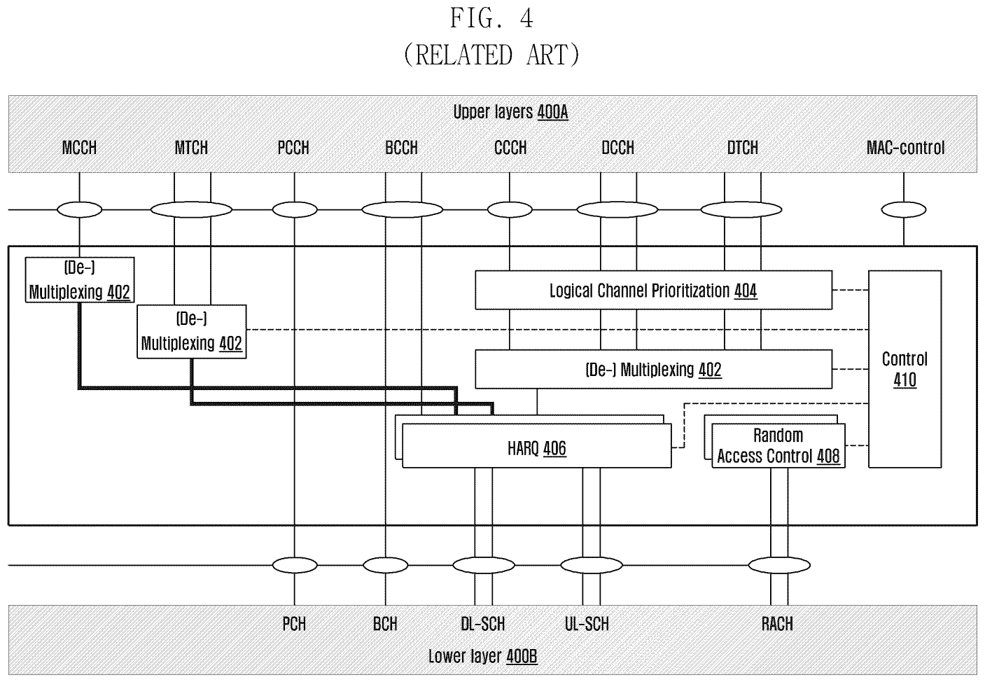

FIG. 4 is a schematic diagram that illustrates an overview of a medium access control (MAC) structure according to the related art.

Referring to FIG. 4, the MAC structure includes upper layers 400A, bottom layers 400B, a de-multiplexing 402, a logical channel prioritization 404, a HARQ 406, a random access control 408, and a control 410. The main services and functions of the MAC sublayer include: mapping between logical channels and transport channels, multiplexing/de-multiplexing of MAC SDUs belonging to one or different logical channels into/from transport blocks (TB) delivered to/from the physical layer on transport channels, scheduling information reporting, error correction through HARQ (one HARQ entity per cell in case of CA), priority handling between UEs by means of dynamic scheduling, priority handling between logical channels of the UE 200 by means of logical channel prioritisation, priority handling between overlapping resources of the UE 200, padding, and the like.

A single MAC entity can support multiple numerologies, transmission timings, and cells. Mapping limitations in the control of logical channel prioritization, including the numerology (IES), cell(s), and transmission timing(s) that a logical channel is permitted to utilize.

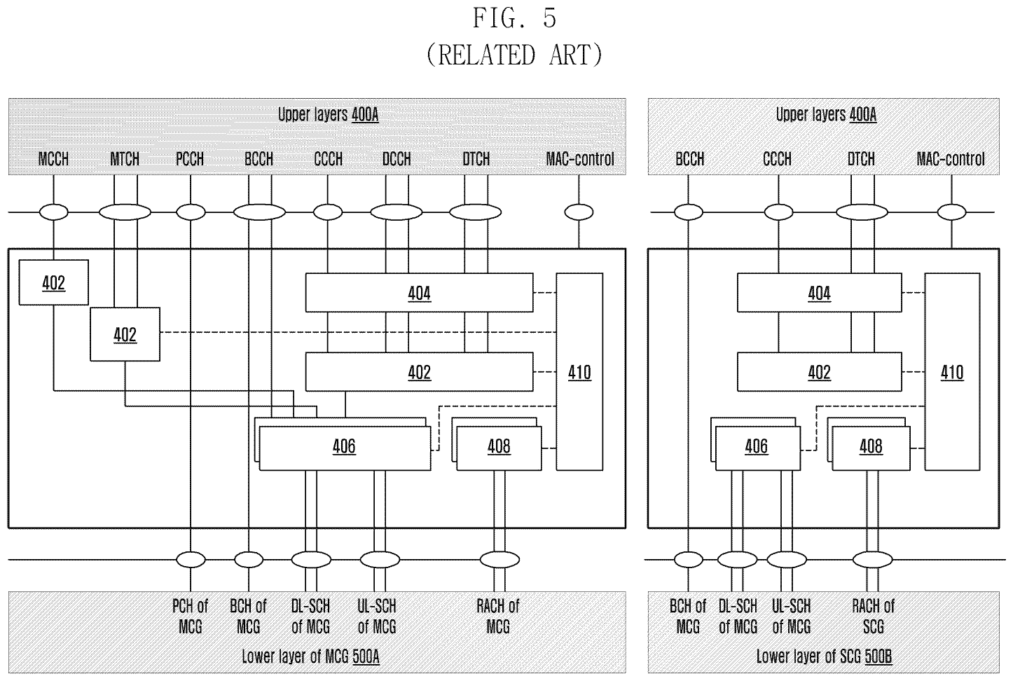

FIG. 5 is a schematic diagram that illustrates the MAC structure overview with two MAC entities according to the related art.

Referring to FIG. 5, the MAC structure includes the upper layers 400A, a lower layer of MCG 500A, and a lower layer of SCG 500B. FIG. 5 illustrates one possible structure for the MAC entities when MCG and SCG are configured. The MAC entity of the UE 200 handles the transport channels. When the UE 200 is configured with SCG, two MAC entities are configured to the UE 200, one for the MCG and one for the SCG. When the UE 200 is configured with DAPS handover, two MAC entities are used by the UE 200: one for the source cell (source MAC entity) and one for the target cell (target MAC entity).

The functions of the different MAC entities in the UE 200 operate independently unless otherwise specified. The timers and parameters used in each MAC entity are configured independently unless otherwise specified. The Serving Cells, C-RNTI, radio bearers, logical channels, upper and lower layer entities, LCGs, and HARQ entities considered by each MAC entity refer to those mapped to that MAC entity unless otherwise specified.

If the MAC entity is configured with one or more SCells, there are multiple downlink shared channel (DL-SCH) and there may be multiple uplink shared channel (UL-SCH) as well as multiple RACH per MAC entity; one DL-SCH, one UL-SCH, and one RACH on the SpCell, one DL-SCH, zero or one UL-SCH and zero or one RACH for each SCell. If the MAC entity is not configured with any SCell, there is one DL-SCH, one UL-SCH, and one RACH per MAC entity.

The proposed solution provides a method and system for performing power ramping for early timing advance synchronization. In an embodiment, the random access procedure is initiated by the PDCCH order for an LTM candidate cell. Further, a verification is done for the cell to which the UE 200 performed the last Random Access Preamble transmission belong to the same cell group as the LTM candidate cell or not. If it belongs to the same cell group, then PREAMBLE_POWER_RAMPING_COUNTER is set to 1 else the value of the PREAMBLE_POWER_RAMPING_COUNTER is kept same.

In an embodiment, if the random access procedure is initiated by the PDCCH order for an LTM candidate cell, which is different from the cell on the same cell group to which the UE 200 performed the last Random Access Preamble transmission, and the PDCCH order indicates preamble re-transmission, the UE 200 sets PREAMBLE_POWER_RAMPING_COUNTER to 1.

In an embodiment, if the random access procedure is initiated by the PDCCH order for an LTM candidate cell, which is different from the cell on the different cell group to which the UE 200 performed the last Random Access Preamble transmission, and the PDCCH order indicates preamble re-transmission, the UE 200 keeps the PREAMBLE_POWER_RAMPING_COUNTER value (i.e. it doesn't reset the power ramping counter to 1).

In an embodiment, if the random access procedure is initiated by the PDCCH order for an LTM candidate cell in SCG and the UE 200 receives PDCCH order for any cell on the MCG, the UE 200 keeps the same preamble power ramping counter.

In an embodiment, UE MAC entities share the status of the PDCCH order reception with each other. Similarly MN and SN may share the details of the PDCCH order send to MCG and SCG respectively through inter-node RRC messages such as CG-ConfigInfo.

In the prior art, if the UE 200 has received a PDCCH order for an LTM candidate cell for MCG and the previous random access transmission was on SCG, or vice-versa, the power ramping needs to be reset. This will incur complex interaction between the MAC entities of MCG and SCG. The issue gets more complex in the network side, as the MAC entities for MCG and SCG are residing on two different nodes and their interaction is particularly complex due to the transport path in between them.

In contrast to the current systems, the proposed solution describes a method wherein a verification is done for the cell to which the UE 200 performed the last Random Access Preamble transmission belong to the same cell group as the LTM candidate cell or not. If it belongs to the same cell group, then PREAMBLE_POWER_RAMPING_COUNTER is set to 1 else the value of the PREAMBLE_POWER_RAMPING_COUNTER is kept same.

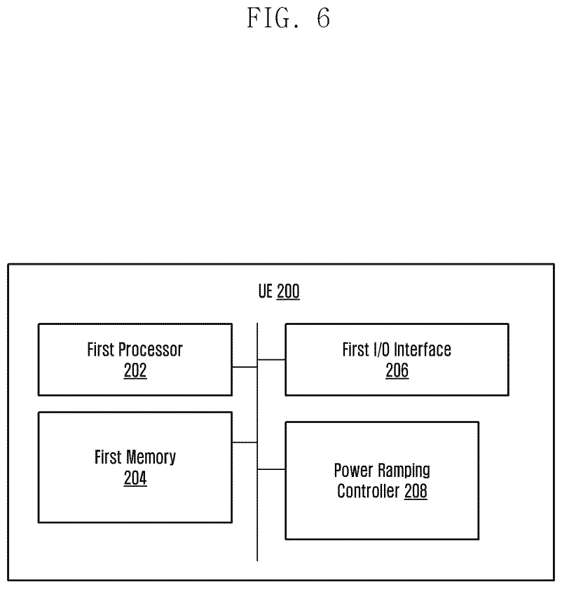

FIG. 6 is a schematic diagram that illustrates a schematic of the UE 200 implemented to carry out the disclosed subject matter according to an embodiment of the disclosure.

Examples of the UE 200 can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

Referring to FIG. 6, the UE 200 includes a first processor 202, first memory 204, a first input/output (I/O) interface (transceiver) 206, and a power ramping controller 208 coupled to the first processor 202 and the first memory 204. The components are explained in further detail below.

The first processor 202 communicates with the first memory 204, the first I/O interface 206, and the power ramping controller 208. The first processor 202 is configured to execute instructions stored in the first memory 204 and to perform various processes. The first processor 202 includes one or a plurality of processors, is a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). The first processor 202 and the power ramping controller 208 can be a same entity or a different entity.

The first memory 204 includes storage locations to be addressable through the first processor 202. The first memory 204 stores information regarding the cell to which the UE 200 performed the last random access preamble transmission and a value of the preamble power ramping counter. The first memory 204 is not limited to volatile memory and/or non-volatile memory. Further, the first memory 204 includes a plurality of computer-readable storage media. The first memory 204 includes non-volatile storage elements. For example, non-volatile storage elements includes magnetic hard disks, optical disks, floppy disks, flash memories, or forms of electrically programmable memories (EPROM) or electrically erasable and programmable (EEPROM) memories.

The first I/O interface 206 transmits the information between the first memory 204 and external peripheral devices. The peripheral devices are the input-output devices associated with the UE 200. Further, the power ramping controller 208 communicates with the first I/O interface 206 and the first memory 204. The power ramping controller 208 is coupled to the first memory 204 and the first processor 202. This coupling allows for efficient data transfer and communication between the components, ensuring that the power ramping controller 208 can perform a power ramping for early timing advance synchronization.

The power ramping controller 208 is an innovative integrated circuit that is implemented in the UE 200. In an embodiment, the structure of such innovative integrated circuit includes a multi-core architecture that enables performing a power ramping for early timing advance synchronization. Each core is optimized for specific tasks, such as initiating a random access procedure, setting a random access of the preamble power ramping counter, skipping a reset of the preamble power ramping counter, and the like. The innovative integrated circuit for the above-mentioned points is made of a combination of analog and digital components designed to enable performing a power ramping for early timing advance synchronization. The analog components include a low-noise amplifier and a high-precision analog-to-digital converter to ensure accurate signal processing. The digital components consist of a microcontroller unit (MCU) and a digital signal processor (DSP) that work in tandem to enable performing a power ramping for early timing advance synchronization.

In an embodiment, the power ramping controller 208 initiates a random access procedure by a PDCCH order for an LTM candidate cell. The random access procedure refers to a specific method used in 5G NR or LTE networks on a target secondary cell or candidate cell. The PDCCH order is a command sent by the gNB 102 via the PDCCH to instruct the UE 200 to perform a random access (RA) procedure on a specific cell. The PDCCH order can indicate preamble transmission or a preamble-retransmission. Further, the LTM candidate cell refers to a cell that the UE 200 has reported or the network has configured for potential future use (e.g., for beam recovery, mobility, etc.). The random access procedure improves connection recovery in scenarios like beam failure, mobility, or poor radio conditions.

In an embodiment, the power ramping controller 208 determines whether a cell to which the UE 200 performed a last random access preamble transmission is different from the LTM candidate cell. The power ramping controller 208 also determines whether the cell belongs to a same cell group of the LTM candidate cell. The last random access preamble transmission refers to a most recent transmission by the UE 200 of a random access preamble. It marks the latest attempt to initiate or recover radio connection or synchronize with the gNB 102 and is key in managing retries, timers, and mobility strategies.

In an embodiment, the power ramping controller 208 sets a preamble power ramping counter associated with a random access to ‘one’ when the cell belongs to the same cell group of the LTM candidate cell. The preamble power ramping counter refers to a counter the counts how many times the UE 200 has retransmitted the random access preamble while increasing the transmission power each time. This occurs due to no response from the gNB 102. Else, the power ramping controller 208 skips a reset of the preamble power ramping counter to ‘one’ when the cell does not belong to the same cell group of the LTM candidate cell. The UE 200 retains a same value of the preamble power ramping counter when the cell does not belong to the same cell group of the LTM candidate cell.

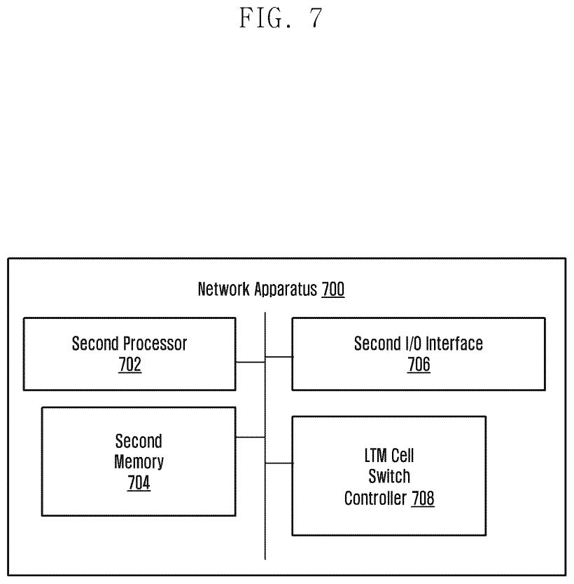

FIG. 7 is a schematic diagram that illustrates a schematic of a network apparatus implemented to carry out the disclosed subject matter according to an embodiment of the disclosure.

Referring to FIG. 7, a network apparatus 700 includes various hardware and software components that facilitate communication between user equipment and network infrastructure. Examples of the network apparatus 700 can include, but is not limited to Base Stations (such as macro cells, small cells, femtocells, Pico cells) for wireless communication, Antennas and RF Units (e.g., MIMO, beamforming) to enhance signal coverage and data throughput, Core Network Equipment (e.g., mobility management entities (MMEs), serving gateways (S-GWs), packet data network gateways (P-GWs) in fourth generation (4G); AMFs, user plane functions (UPFs) in 5G) for data routing, mobility, and session control, Network Function Virtualization (NFV) and Software-Defined Networking (SDN) for dynamic resource allocation and scalability, Edge Computing Nodes (e.g., MEC servers) for low-latency processing, Backhaul and Transport Equipment (e.g., fiber-optic links, microwave relays, Ethernet switches) to connect base stations to the core network, Network Management Systems (NMS) and Operation Support Systems (OSS) for network configuration, fault management, and optimization, Radio Network Controllers (RNCs) in 3G, Distributed Units (DUs), and Centralized Units (CUs) in 5G, Network Slicing Components for virtualized resource allocation, Security elements (e.g., Firewalls, IDS, AAA Servers) for secure communication.

In an embodiment, in FIG. 7, the network apparatus 700 includes a second processor 702, second memory 704, a second I/O interface (transceiver) 706, and an LTM cell switch controller 708 coupled to the second processor702 and the second memory 704. The components are explained in further detail below.

The second processor 702 communicates with the second memory 704, the second I/O interface 706, and the LTM cell switch controller 708. The second processor 702 is configured to execute instructions stored in the second memory 704 and to perform various processes. The second processor 702 includes one or a plurality of processors, is a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). The second processor 702 and the LTM cell switch controller 708 can be a same entity or a different entity.

The second memory 704 includes storage locations to be addressable through the second processor 702. The second memory 704 stores an LTM configuration received via a SRB1 included in a MRDC-SCG configuration. The second memory 704 is not limited to volatile memory and/or non-volatile memory. Further, the second memory 704 includes a plurality of computer-readable storage media. The second memory 704 includes non-volatile storage elements. For example, non-volatile storage elements include magnetic hard disks, optical disks, floppy disks, flash memories, or forms of electrically programmable memories (EPROM) or electrically erasable and programmable (EEPROM) memories.

The second I/O interface 706 transmits the information between the second memory 704 and external peripheral devices. The peripheral devices are the input-output devices associated with the network apparatus 700. Further, the LTM cell switch controller 708 communicates with the second I/O interface 706 and the second memory 704. The LTM cell switch controller 708 is coupled to the second memory 704 and the second processor 702. This coupling allows for efficient data transfer and communication between the components, ensuring that the LTM cell switch controller 708 can perform the LTM cell switch execution in the communication system.

The LTM cell switch controller 708 is an innovative integrated circuit that is implemented in the network apparatus 700. In an embodiment, the structure of such innovative integrated circuit includes a multi-core architecture that enables performing the LTM cell switch execution in the communication system. Each core is optimized for specific tasks, such as generating a RRC reconfiguration message for an intra-SN LTM candidate cell, transmitting the RRC reconfiguration message via the SRB1 within the NR-SCG to the UE 200, and the like. The innovative integrated circuit for the above-mentioned points is made of a combination of analog and digital components designed to enable performing the LTM cell switch execution in the communication system. The analog components include a low-noise amplifier and a high-precision analog-to-digital converter to ensure accurate signal processing. The digital components consist of a microcontroller unit (MCU) and a digital signal processor (DSP) that work in tandem to enable performing the LTM cell switch execution in the communication system.

In an embodiment, the LTM cell switch controller 708 generates a RRC reconfiguration message for an intra-SN LTM candidate cell. The RRC Reconfiguration message for an intra-SN LTM candidate cell refers to a control message sent by the network apparatus 700 to the UE 200. In NR, the message is a RRCReconfiguration message. This message can be used to instruct the UE 200 to switch its serving cell to a new cell within the same network apparatus 700. This enables seamless mobility. The LTM cell switch controller 708 then transmits the RRC reconfiguration message via the SRB1 within the NR-SCG to the UE 200.

In an embodiment, the LTM cell switch controller 708 receives a RRC reconfiguration complete message via the SRB1 embedded in a NR RRC in an UL information transfer MRDC from the UE 200. The RRC reconfiguration complete message is an UL message such as NR RRCReconfigurationComplete message used to inform the network apparatus 700 that RRC Reconfiguration is successful. The UL Information transfer MRDC is an UI message such as NR ULInformationTransferMRDC message used for the uplink transfer of MR-DC dedicated information (e.g. for transferring the NR or E-UTRA RRC MeasurementReport message, the FailureInformation message etc. in NR) This is received when the RRC reconfiguration message is applied due to the LTM cell switch execution configured via the LTM configuration received via the SRB1 included in a MRDC-SCG configuration.

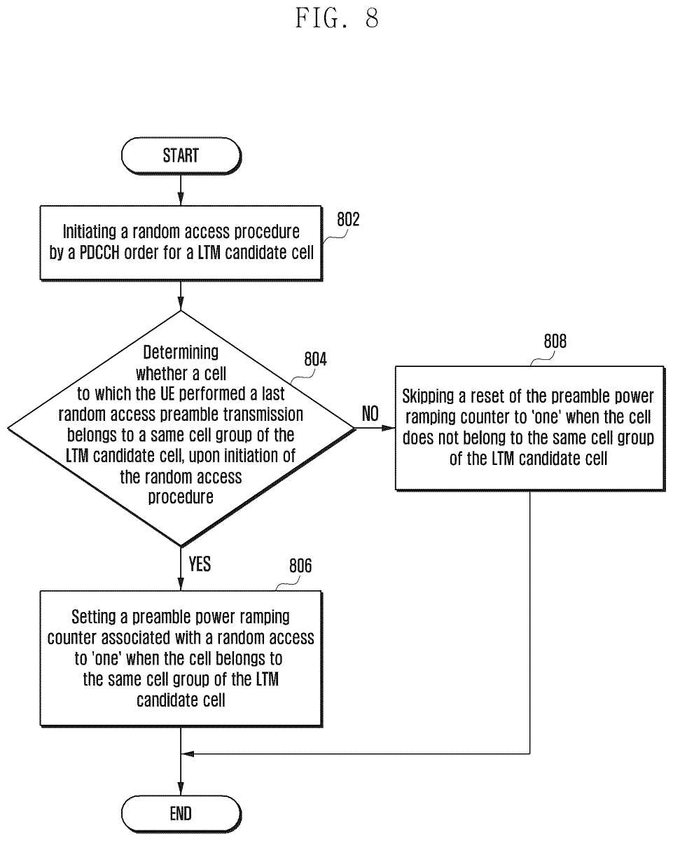

FIG. 8 is a flow diagram that illustrates a method for performing a power ramping for early timing advance synchronization in a communication system according to an embodiment of the disclosure.

Referring to FIG. 8 the method includes operations 802-808. Each operation is explained in further detail below.

At operation 802, UE 200 initiates the random access procedure by a PDCCH order for an LTM candidate cell. The random access procedure refers to a specific method used by the UE 200 in wireless networks to synchronize with the network apparatus 700.

At operation 804, the UE 200 determines whether a cell to which the UE 200 performed a last random access preamble transmission is different from the LTM candidate cell and whether the cell belongs to a same cell group of the LTM candidate cell. This is determined upon initiation of the random access procedure.

In an embodiment, at operation 806, if the Random Access procedure is initiated by the PDCCH order for an LTM candidate cell, which is different from the cell to which the UE 200 performed the last Random Access Preamble transmission for the same cell group, and the PDCCH order indicates preamble re-transmission, the UE 200 sets preamble power ramping counter, PREAMBLE_POWER_RAMPING_COUNTER to 1.

In an embodiment, at operation 808, if the Random Access procedure is initiated by the PDCCH order for an LTM candidate cell, which is different from the cell to which the UE 200 performed the last Random Access Preamble transmission for the different cell group, and the PDCCH order indicates preamble re-transmission, the UE 200 keeps the preamble power ramping counter, PREAMBLE_POWER_RAMPING_COUNTER value (i.e. it doesn't reset the power ramping counter to 1).

In an embodiment, if the Random Access procedure is initiated by the PDCCH order for an LTM candidate cell, which is different from the cell to which the MAC entity performed the last Random Access Preamble transmission, and the PDCCH order indicates preamble re-transmission, the MAC entity sets PREAMBLE_POWER_RAMPING_COUNTER to 1. In an embodiment, different MAC entities may be used for dual connectivity. One of the MAC entities may be used or MCG and another MAC entity may be used for SCG.

If the random access procedure is initiated by the PDCCH order for an LTM candidate cell in MCG and the last RA preamble transmission was performed for any cell on the SCG, the UE 200 keeps the same preamble power ramping counter.

If the random access procedure is initiated by the PDCCH order for an LTM candidate cell in MCG and the last RA preamble transmission was performed for any cell on the MCG, the UE 200 sets the preamble power ramping counter to 1.

If the random access procedure is initiated by the PDCCH order for an LTM candidate cell in SCG and the last RA preamble transmission was performed for any cell on the SCG, the UE 200 sets the preamble power ramping counter to 1. If the random access procedure is initiated by the PDCCH order for an LTM candidate cell in SCG and the last RA preamble transmission was performed for any cell on the MCG, the UE 200 keeps the same preamble power ramping counter.

In an embodiment, according to TS 38.321, when the Random Access procedure is initiated on a Serving Cell or for an LTM candidate cell, the MAC entity shall:
1> flush the Msg3 buffer;
1> flush the MSGA buffer;
1> set the PREAMBLE_TRANSMISSION_COUNTER to 1;
1> if the Random Access procedure is initiated on a Serving Cell; or
1> if the Random Access procedure is initiated by the PDCCH order for an LTM candidate cell and the PDCCH order indicates preamble initial transmission; or
1> if the Random Access procedure is initiated by the PDCCH order for an LTM candidate cell, which is different from the cell to which the MAC entity performed the last Random Access Preamble transmission, and the PDCCH order indicates preamble re-transmission:
   2> set the PREAMBLE_POWER_RAMPING_COUNTER to 1;
1> set the PREAMBLE_BACKOFF to 0 ms;

In an embodiment, UE MAC entities share the status of the PDCCH order reception with other MAC entities in the UE 200. Similarly MN and SN may share the details of the PDCCH order send to MCG and SCG respectively through inter-node RRC messages such as CG-ConfigInfo.

The introduction of the LTM in the 3GPP Release 18 marks a significant advancement in addressing the challenges associated with existing Layer 3 mobility, particularly in terms of latency and signaling overhead. Traditionally, mobility management in cellular networks has relied heavily on Layer 3 signaling, which can introduce considerable latency and interruption times due to the complexity and volume of signaling messages exchanged between the UE 200 and the network apparatus 700. The LTM aims to streamline this process by leveraging Layer 1 and Layer 2 signaling to facilitate faster and more efficient cell changes. By enabling serving cell changes through L1/L2 signaling, LTM reduces the latency overhead and minimizes the interruption time experienced by users during mobility events. This approach enhances the user experience by providing seamless connectivity and optimizes network resources by reducing the signaling load on the network infrastructure.

In the context of the LTM, the network apparatus 700 (for example the gNB 102), configures the UE 200 with multiple candidate cells. This configuration allows for the rapid application of pre-defined settings for these candidate cells, thereby enabling swift transitions from one cell to another. The network can dynamically switch the UE 200 from a source cell to one of the configured candidate cells using Medium Access Control Element (MAC CE) or L1 signaling. This dynamic switching capability is further enhanced by the use of L1 measurements, which provide a more immediate and responsive basis for triggering mobility events compared to existing L3 measurements. The gNB Central Unit (CU) is responsible for providing the LTM Candidate Configuration, which involves configuring LTM candidate cells through a single RRCReconfiguration message. This streamlined configuration process simplifies the management of candidate cells and ensures that the UE 200 is prepared for potential cell changes.

Further, the LTM supports the concept of subsequent LTM, which allows for continuous mobility management even after an initial LTM event. Once the UE 200 moves to a candidate cell through LTM, it can store the LTM configuration of other candidate cells, enabling it to remain agile and responsive to further mobility events. The gNB 102 can release or modify candidate configurations as needed, ensuring that the UE 200 is equipped with the most relevant and up-to-date information for performing LTM measurements and reporting. This ongoing process of measurement and reporting allows the UE 200 to maintain connectivity and performance as it transitions between cells. Subsequent LTM ensures that even after a candidate cell becomes a source cell due to LTM, the UE 200 can continue to store LTM candidate configurations and report LTM measurements. The new serving cell can then send an LTM cell switch command to the UE 200, prompting it to perform another LTM event. This capability for subsequent LTM underscores the flexibility and efficiency of the LTM approach, providing a robust framework for managing mobility in next-generation networks.

In NR-DC, the UE 200 may receive two independent ltm-Config: an ltm-Config associated with the MCG that is included within an RRCReconfiguration message received via SRB1, and an ltm-Config associated with the SCG that is included within an RRCReconfiguration message either received via SRB3 or alternatively embedded in an RRCReconfiguration message received via the SRB1.

The UE 200 performs the L1 measurements on the source cell and candidate cell and reports the L1 measurements through CSI reports to the gNB DUs 102B of the source cell. The gNB DUs 102B may send a MAC CE (for e.g., LTM MAC CE or cell switch MAC CE) asking the UE 200 to switch to another cell, which is an LTM candidate cell. The UE 200 may perform random access during LTM cell switch, or the cell switch may be RACH-less. Cell Switch may be guarded by a timer (referred to as T3xx).

The UE 200 may be requested to perform random access on a candidate cell before the cell switch so that the network can calculate the timing advance before the cell switch and inform the UE 200 either through a random access response or within the MAC CE, which is sent for the cell switch. The gNB 102 may configure the UE 200 to perform random access towards one or more LTM candidate cells for receiving the timing advance (TA) before the cell switch is performed (known as Early TA or Early Sync TA or TA for Early Sync). Random access performed on LTM candidate cells for the timing advance reception is known as random access for early TA. The gNB 102 sends a PDCCH order to initiate RACH for TA measurement for candidate cells. The UE 200 receives the PDCCH order from the serving cell. Upon reception of this PDCCH order, the UE 200 initiates RACH for TA measurement for candidate cells on the one or more candidate cell. The UE 200 sends RACH preamble to the candidate cells and receives the Timing Advance (TA) value from the candidate cell. The TA for candidate cells may be received from the source cell also. The TA will be received in the random access response, but it may also be received through a MAC CE. If the source DU indicates the UE 200 to retransmit the RACH for early TA, the UE 200 retransmits the same. The gNB 102 may also send the PDCCH order to retransmit RACH for the TA measurement (also known as RACH for early sync).

Upon successfully performing LTM cell switch, the UE 200 sends RRCReconfigurationComplete. In case of Rel-18 Intra-SN LTM in NR-DC, RRCReconfigurationComplete may be sent over SRB3, or it may be sent in ULIinformationTransfer-MRDC message. While Rel-18 of 3gpp supported LTM within the same gNB CU 102A, Rel-19 is planning to introduce Inter-CU LTM. For SN LTM, both intra-SN LTM and inter-SN LTM can be configured simultaneously. For Inter-CU SCG LTM configuration, SN generates SCG part configuration MN includes it into its MN RRC configuration message. For inter-CU SCG LTM, the LTM cell switch command MAC CE is sent by source SN. Upon execution of inter-SN SCG LTM, the UE 200 sends an MN RRCReconfigurationComplete message to the MN, which includes an SN RRCReconfigurationComplete message.

If the UE 200, which is configured with both intra-SN LTM and inter-SN LTM simultaneously, executes LTM cell switch, it needs to be defined how it informs the complete message for the SCG, i.e., how does the UE 200 send the SCG RRCReconfigurationComplete to the network.

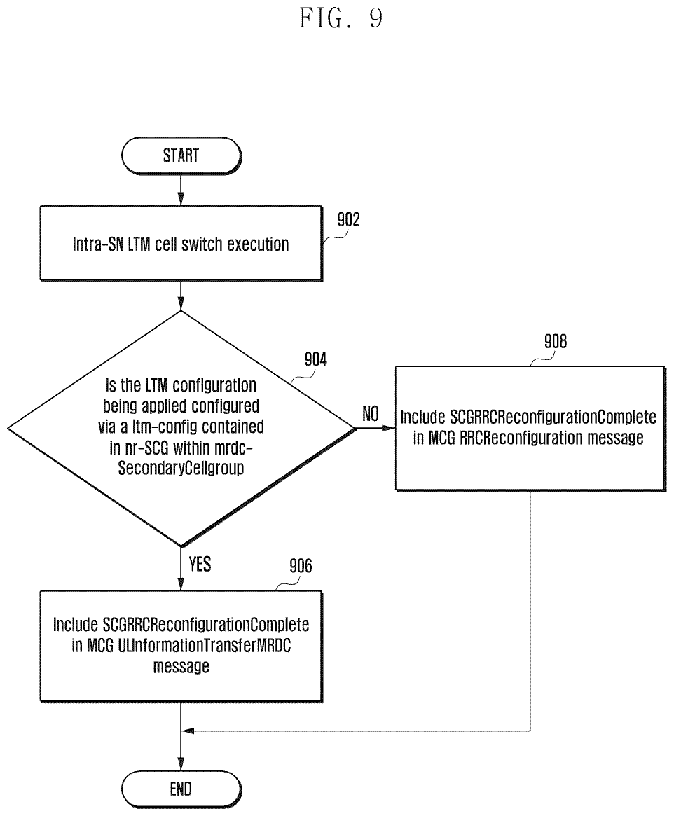

The following embodiments solve the above problem scenario. Referring now to the drawings and more particularly to FIG. 9, where similar reference characters denote corresponding features throughout the figures, there are shown preferred embodiments.

FIG. 9 is a flow diagram that illustrates a method for performing an LTM cell switch execution in a communication system according to an embodiment of the disclosure.

Referring to FIG. 9, the method includes operations 902-908. Each operation is explained in further detail below.

In an embodiment, at operation 902, the method performs the Intra-SN LTM cell switch execution. At operation 904, the method determines if LTM configuration being applied is configured via ltm-config contained in nr-SCG within mrdc-SecondaryCellgroup. At operation 906, the method includes SCGRRCReconfigurationComplete in MCG RRCReconfiguration message when the LTM configuration being applied is not configured via ltm-config contained in nr-SCG within mrdc-SecondaryCellgroup. At operation 908, the method includes SCG RRCReconfigurationComplete in MCG ULInformationTransferMRDC message when the LTM configuration being applied is configured via ltm-config contained in nr-SCG within mrdc-SecondaryCellgroup.

In an embodiment, when executing an intra-SN LTM cell switch, if the UE 200 is configured with both intra-SN LTM and inter-SN LTM simultaneously, the UE 200 sends the SCG RRCReconfigurationComplete message embedded within an MCG RRCReconfigurationComplete message. In this scenario, the UE 200 in NR may include the field nr-SCG-Response in the MCG RRCReconfigurationComplete message. The SCG RRCReconfigurationComplete message is sent in the nr-SCG-Response field of the MCG RRCReconfigurationComplete message. The MN extracts the SCG RRCReconfigurationComplete for the intra-SN LTM from the MCG RRCReconfigurationComplete and forwards it to the target SN.

In an embodiment, when executing an intra-SN LTM cell switch, if the UE 200 is configured solely with intra-SN LTM (i.e., not configured with inter-SN LTM), the UE 200 sends the SCG RRCReconfigurationComplete in the ULInformationTransferMRDC RRC message. In such a case, the UE 200 may include the field UL-DCCH-MessageNR of ULInformationTransferMRDC and send the SCG RRCReconfigurationComplete message in the UL-DCCH-MessageNR field of the MCG RRCReconfigurationComplete message, in NR. The MN extracts the SCG RRCReconfigurationComplete for the intra-SN LTM from ULInformationTransferMRDC and forwards it to the target SN. This occurs unless the intra-SN LTM configuration (intra SN ltm-config corresponding to the executed LTM switch) is associated with the MCG.

In an embodiment, when executing an intra-SN LTM cell switch, if the UE 200 is configured solely with intra-SN LTM (i.e., not configured with inter-SN LTM and the intra-SN LTM configuration (intra-SN LTM-config corresponding to the executed LTM switch) is associated with the Secondary Cell Group (SCG), the UE 200 sends the SCG RRCReconfigurationComplete message embedded within a Master Cell Group (MCG) RRCReconfigurationComplete message. In this scenario, in New Radio (NR), the UE 200 may include the field nr-SCG-Response in the MCG RRCReconfigurationComplete message and send the SCG RRCReconfigurationComplete message in the nr-SCG-Response field of the MCG RRCReconfigurationComplete message. The MN extracts the SCG RRCReconfigurationComplete for the intra-SN LTM from the MCG RRCReconfigurationComplete and forwards it to the target Secondary Node (SN).

In NR, the Inter-SN LTM cell switch configuration is associated with MCG. Intra-SN LTM cell switch configuration can be associated with either MCG or SCG. If the Intra-SN LTM cell configuration corresponding to the LTM cell switch is associated with MCG, the UE 200 sends the SCG RRCReconfigurationComplete embedded in an MCG RRCReconfigurationComplete message. If the Intra-SN LTM cell configuration corresponding to the LTM cell switch is associated with SCG, the UE 200 sends SCG RRCReconfigurationComplete in the ULInformationTransferMRDC RRC message.

Though typically intra-SN LTM configuration is associated with MCG, when it is configured simultaneously with inter-SN LTM configuration, a network node may sometimes configure intra-SN LTM configuration as associated with SCG even when inter-SN LTM configuration is not present. For example, both the intra-SN and inter-SN LTM configuration may be present together, and intra-SN LTM configuration may be associated with MCG. Later, the RAN node may delete inter-SN LTM configuration but may not reconfigure the intra-SN LTM configuration to associate it with SCG. Similarly, the RAN node may configure intra-SN LTM configuration as associated with MCG if it foresees a possibility for inter-SN LTM configuration later.

In an embodiment, according to TS 38.331:
1> set the content of the RRCReconfigurationComplete message as follows:
2> if the RRCReconfiguration message includes the mrdc-SecondaryCellGroupConfig with mrdc-SecondaryCellGroup set to nr-SCG:
3> include in the nr-SCG-Response the SCG RRCReconfigurationComplete message;
if the UE 200 is configured with E-UTRA nr-SecondaryCellGroupConfig (the UE 200 in (NG) EN-DC):
<some texts>
1> else if the RRCReconfiguration message was received via SRB1 within the nr-SCG within mrdc-SecondaryCellGroup (the UE 200 in NR-DC, mrdc-SecondaryCellGroup was received in RRCReconfiguration or RRCResume via SRB1):
2> if the RRCReconfiguration is applied due to a conditional reconfiguration execution for CPC or subsequent CPAC which is configured via conditionalReconfiguration contained in nr-SCG within mrdc-SecondaryCellGroup; or
2> if the RRCReconfiguration is applied due to an LTM cell switch execution which is configured via ltm-config contained in nr-SCG within mrdc-SecondaryCellGroup:
Submit the RRCReconfigurationComplete message via SRB1 embedded in NR RRC message ULInformationTransferMRDC as specified in clause 5.7.2a.3.
2> else (in context of LTM else means, if the RRCReconfiguration is applied due to an LTM cell switch execution which is not configured via ltm-config contained in nr-SCG within mrdc-SecondaryCellGroup)
3> Don't submit the RRCReconfigurationComplete message via SRB1 embedded in NR RRC message ULInformationTransferMRDC as specified in clause 5.7.2a.3

In an embodiment, the ltm-Config in the context of specification could be the ltm-Config that carried the LTM candidate configuration for the target cell where the LTM cell switch occurred. The proposed solution considerably simplifies the UE 200 and the network implementation. For example, when the intra-SN LTM and inter-SN LTM are configured together, MN may receive additional information along with SCG Reconfiguration Complete, which could be useful for subsequent Inter-SN LTM configurations and execution. Thus, using MN RRCReconfigurationComplete to carry the SN RRCReconfigurationComplete is preferred. If the intra-SN LTM alone is configured, there is no need for this MN handling for subsequent LTM configurations. So, using ULInformationTransferMRDC is preferred.

The technical advantages lie primarily in the ability to streamline both the UE 200 and network implementation processes, particularly in scenarios involving intra-SN and inter-SN LTM. Traditionally, managing these configurations required complex signaling and coordination between multiple network elements, which could lead to inefficiencies and increased latency. However, the proposed solution introduces a more efficient method by allowing the MN to receive additional information alongside the SCG Reconfiguration Complete message. This additional information is crucial as it provides the necessary context for subsequent inter-SN LTM configurations and executions. By embedding the SN RRCReconfigurationComplete within the MN RRCReconfigurationComplete, the proposed solution ensures that the UE 200 may seamlessly transition between different network configurations without the need for extensive signaling overhead.

Furthermore, the proposed solution offers flexibility by distinguishing between scenarios where only intra-SN LTM is configured and those where both intra-SN and inter-SN LTMs are involved. In cases where only intra-SN LTM is configured, there is no requirement for the MN to handle additional information for future LTM configurations. This simplification allows for the use of ULInformationTransferMRDC, which is more suitable for such scenarios. By optimizing the signaling process based on the specific configuration requirements, the proposed solution reduces unnecessary data exchange and processing, thereby enhancing the overall efficiency of the network.

In addition to simplifying the configuration process, the proposed solution also contributes to improved network performance and user experience. By minimizing the signaling load and reducing the complexity of network operations, the disclosure helps in lowering the potential for errors and delays in communication. The streamlined approach not only enhances the robustness of the network but also supports the scalability of network operations 700, making it easier to accommodate an increasing number of users and devices.

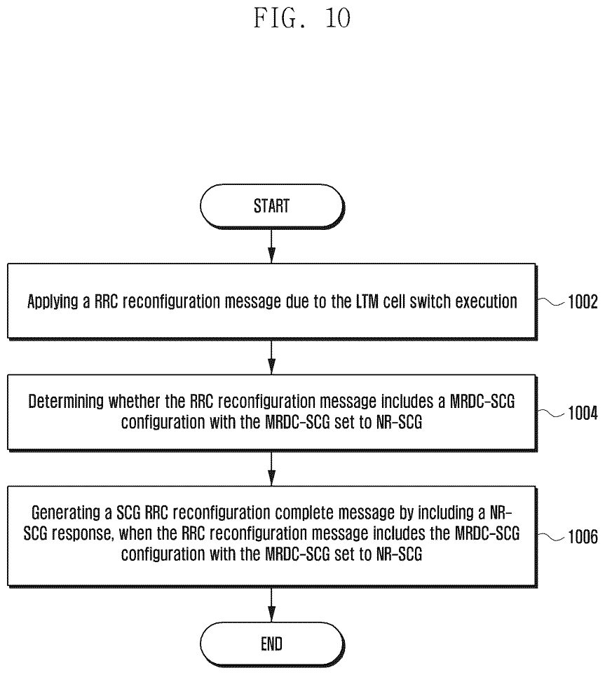

FIG. 10 is a flow diagram that illustrates a method for performing an LTM cell switch execution in a communication system by the UE 200 according to an embodiment of the disclosure.

Referring to FIG. 10, the method includes operations 1002-1006. Each operation is explained in further detail below.

At operation 1002, the UE 200 applies a RRC reconfiguration message due to the LTM cell switch execution. The RRC reconfiguration message refers to a control message that updates radio configuration parameters associated with the UE 200. For example, the radio configuration parameters include bearers, measurements, mobility, and the like. The LTM cell switch execution refers to a process in which the UE 200 is instructed (via RRC Reconfiguration) to switch its monitored cell in RRC_INACTIVE to a better candidate cell.

At operation 1004, the UE 200 determines whether the RRC reconfiguration message includes a MRDC-SCG configuration with the MRDC-SCG set to NR-SCG. The MRDC-SCG configuration refers to an RRC Information Element (IE) that provides the complete configuration for the SCG in the MR-DC setup. For instance, the MRDC-SCG configuration includes security setting for SCG traffic, SCG RRC reconfiguration messages, timers, beam failure information, and the like. The NR-SCG refers to the SCG where the cells belong to the NR (5G) radio access technology. It forms the NR foundation of the MR-DC setup.

At operation 1006, the UE 200 generates a SCG RRC reconfiguration complete message. The SCG RRC reconfiguration complete message is generated when the RRC reconfiguration message includes the MRDC-SCG configuration with the MRDC-SCG set to NR-SCG. It includes a NR-SCG response.

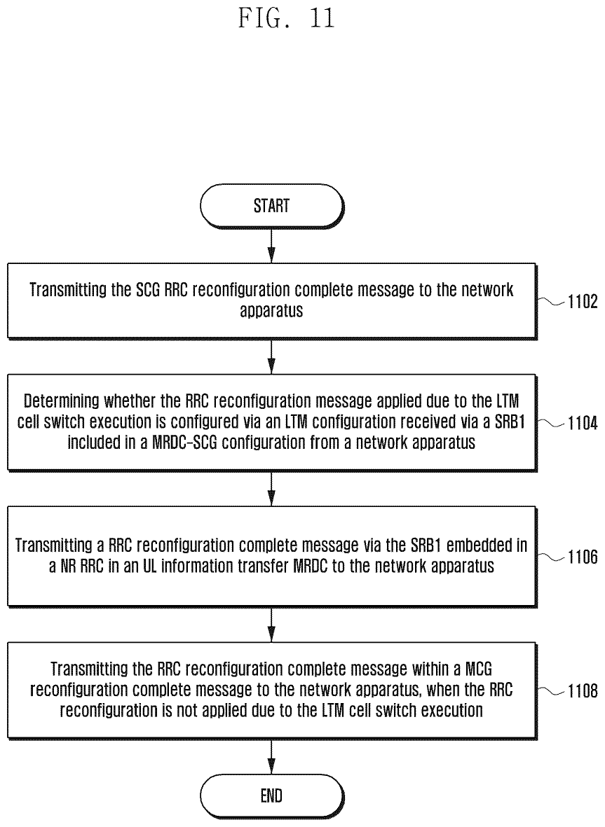

FIG. 11 is a flow diagram that illustrates a method for generating a RRC reconfiguration complete message based on an LTM cell switch execution configuration according to an embodiment of the disclosure.

Referring to FIG. 11, at operation 1102, the UE 200 then transmits the SCG RRC reconfiguration complete message to the network apparatus 700. At operation 1104, the UE 200 determines whether the RRC reconfiguration message applied due to the LTM cell switch execution is configured via an LTM configuration received via a SRB1 included in a MRDC-SCG. The SRB1 is a signalling radio bearer used to carry RRC messages between the UE 200 and the network apparatus 700. It is one of the dedicated signalling bearers used after the initial connection is established.

At operation 1106, the UE 200 transmits a RRC reconfiguration complete message via the SRB1 embedded in a NR RRC in an UL information transfer MRDC to the network apparatus 700. This is transmitted when the RRC reconfiguration message is applied due to the LTM cell switch execution configured via the LTM configuration received via the SRB1 included in the MRDC-SCG configuration from the network apparatus 700. In case the RRC reconfiguration message is not applied due to the LTM cell switch execution, then at operation 1108, the UE 200 transmits the RRC reconfiguration complete message within a MCG reconfiguration complete message to the network apparatus 700.

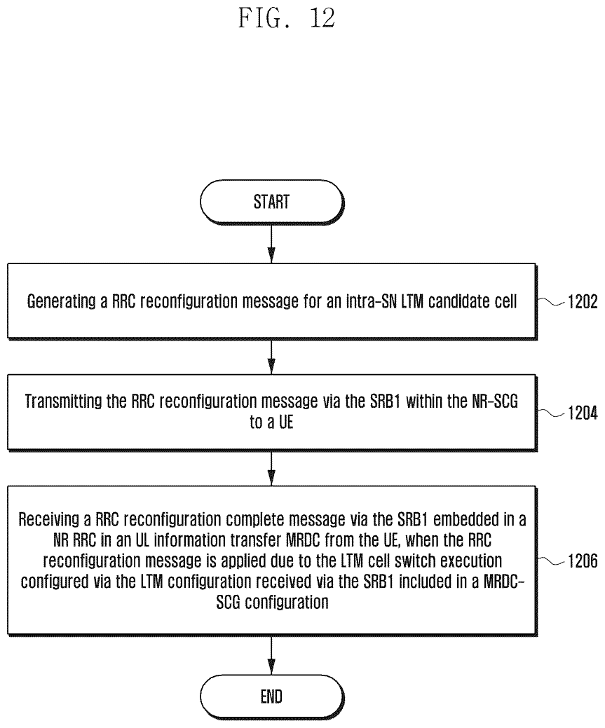

FIG. 12 is a flow diagram that illustrates a method for performing the LTM cell switch execution in a communication system by a network apparatus 700 according to an embodiment of the disclosure.

Referring to FIG. 12, a method includes operations 1202-1206. Each operation is explained in further detail below.

At operation 1202, the network apparatus 700 generates a RRC reconfiguration message for an intra-SN LTM candidate cell. The RRC Reconfiguration message for an intra-SN LTM candidate cell refers to a control message sent by the network apparatus 700 to the UE 200. In NR, the message is a RRCReconfiguration message. This message may be used to instruct the UE 200 to switch its serving cell to a new cell within the same network apparatus 700. This enables seamless mobility. The LTM cell switch controller 708 then transmits the RRC reconfiguration message via the SRB1 within the NR-SCG to the UE 200. At operation 1204, the network apparatus 700 then transmits the RRC reconfiguration message via the SRB1 within the NR-SCG to the UE 200.

At operation 1206, the network apparatus 700 receives a RRC reconfiguration complete message via the SRB1 embedded in a NR RRC in an UL information transfer MRDC from the UE 200. The RRC reconfiguration complete message is an UL message such as NR RRCReconfigurationComplete message used to inform the network apparatus 700 that RRC Reconfiguration is successful. The UL Information transfer MRDC is an UI message such as NR ULInformationTransferMRDC message used for the uplink transfer of MR-DC dedicated information (e.g. for transferring the NR or E-UTRA RRC MeasurementReport message, the FailureInformation message etc. in NR) This is received when the RRC reconfiguration message is applied due to the LTM cell switch execution configured via the LTM configuration received via the SRB1 included in a MRDC-SCG configuration.

The embodiments of the disclosure provide a computer-readable storage medium having stored thereon a computer program, that when executed by a processor, implements the operations and corresponding contents of the foregoing method embodiments.

The embodiments of the disclosure also provide a computer program product including a computer program, that when executed by a processor, implements the operations and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate, so that the embodiments of the disclosure described herein can be implemented in an order other than that illustrated or described in the text.

It should be understood that while the flow diagrams of the embodiments of the disclosure indicate the individual operational operations by arrows, the order in which these operations are performed is not limited to the order indicated by the arrows. Unless explicitly stated herein, in some implementation scenarios of the embodiments of the disclosure, the implementation operations in the respective flowcharts may be performed in other orders as desired. In addition, some, or all of the operations in each flowchart may include multiple sub-operations or multiple phases based on the actual implementation scenario. Some or all of these sub-operations or stages can be executed at the same moment, and each of these sub-operations or stages can also be executed at different moments separately. The order of execution of these sub-operations or stages can be flexibly configured according to requirements in different scenarios of execution time, and the embodiments of the disclosure are not limited thereto.

The above-mentioned description and the drawings are provided merely as examples to help readers to understand the disclosure, and they should not be interpreted or aim to limit the scope of the disclosure in any way. Although some embodiments are provided, it is apparent for those skilled in the art to adopt other similar implementation means based on the technical idea of the disclosure without departing from the technical concepts of the solutions of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
applying a radio resource control (RRC) reconfiguration due to a layer 1/layer 2 triggered mobility (LTM) cell switch execution;
determining whether the RRC reconfiguration due to the LTM cell switch execution is configured via an LTM configuration (LTM-config) information element (IE) contained in new radio secondary cell group (nr-SCG) IE within a multi radio dual connectivity secondary cell group (mrdc-SecondaryCellGroup) IE; and
in case that the RRC reconfiguration due to the LTM cell switch execution is configured via the LTM-config contained in the nr-SCG within the mrdc-SecondaryCellGroup, transmitting, to a base station, an RRC reconfiguration complete message via a signaling radio bearer 1 (SRB1) embedded in NR RRC message uplink information transfer MRDC (ULInformationTransferMRDC).

2. The method of claim 1, further comprising:
in case that the RRC reconfiguration is not applied due to the LTM cell switch execution configured via the LTM-config contained in the nr-SCG within the mrdc-SecondaryCellGroup, transmitting, to the base station, an RRC reconfiguration complete message in a secondary cell group response (SCG-Response) within an master cell group (MCG) RRC reconfiguration complete message.

3. The method of claim 1, wherein the RRC reconfiguration is received via the SRB1.

4. The method of claim 1,
wherein, in case that a random access procedure is initiated by a physical downlink control channel (PDCCH) order for an LTM candidate cell, which is different from a cell to which the terminal performed a last random access preamble transmission for a same cell group, a preamble power counter is to be reset, and
wherein, in case that the random access procedure is initiated by the PDCCH order for the LTM candidate cell, which is different from a cell to which the terminal performed a last random access preamble transmission for a different cell group, the preamble power counter is not to be reset.

5. A method performed by a base station in a wireless communication system, the method comprising:
transmitting, to a terminal, a radio resource control (RRC) reconfiguration message comprising configuration information on a layer 1/layer 2 triggered mobility (LTM) cell switch execution; and
in case that the RRC reconfiguration message is applied due to the LTM cell switch execution and is configured via an LTM configuration (LTM-config) information element (IE) contained in new radio secondary cell group (nr-SCG) IE within a multi radio dual connectivity secondary cell group (mrdc-SecondaryCellGroup) IE, receiving, from the terminal, an RRC reconfiguration complete message via a signaling radio bearer 1 (SRB1) embedded in NR RRC message uplink information transfer MRDC (ULInformationTransferMRDC).

6. The method of claim 5, further comprising:
in case that the RRC reconfiguration message is not applied due to the LTM cell switch execution configured via the LTM-config contained in the nr-SCG within the mrdc-SecondaryCellGroup, receiving, from the terminal, an RRC reconfiguration complete message in a secondary cell group response (SCG-Response) within an master cell group (MCG) RRC reconfiguration complete message.

7. The method of claim 5, wherein the RRC reconfiguration message is transmitted via the SRB1.

8. The method of claim 5,
wherein, in case that a random access procedure is initiated by a physical downlink control channel (PDCCH) order for an LTM candidate cell, which is different from a cell to which the terminal performed a last random access preamble transmission for a same cell group, a preamble power counter is to be reset, and
wherein, in case that the random access procedure is initiated by the PDCCH order for the LTM candidate cell, which is different from a cell to which the terminal performed a last random access preamble transmission for a different cell group, the preamble power counter is not to be reset.

9. A terminal in a wireless communication system, the terminal comprising:
a transceiver; and
a controller coupled with the transceiver and configured to:
apply a radio resource control (RRC) reconfiguration due to a layer 1/layer 2 triggered mobility (LTM) cell switch execution,
determine whether the RRC reconfiguration due to the LTM cell switch execution is configured via an LTM configuration (LTM-config) information element (IE) contained in new radio secondary cell group (nr-SCG) IE within a multi radio dual connectivity secondary cell group (mrdc-SecondaryCellGroup) IE, and
in case that the RRC reconfiguration due to the LTM cell switch execution is configured via the LTM-config contained in the nr-SCG within the mrdc-SecondaryCellGroup, transmit, to a base station, an RRC reconfiguration complete message via a signaling radio bearer 1 (SRB1) embedded in NR RRC message uplink information transfer MRDC (ULInformationTransferMRDC).

10. The terminal of claim 9, wherein the controller is further configured to:
in case that the RRC reconfiguration is not applied due to the LTM cell switch execution configured via the LTM-config contained in the nr-SCG within the mrdc-SecondaryCellGroup, transmit, to the base station, an RRC reconfiguration complete message in a secondary cell group response (SCG-Response) within an master cell group (MCG) RRC reconfiguration complete message.

11. The terminal of claim 9, wherein the RRC reconfiguration is received via the SRB1.

12. The terminal of claim 9,
wherein, in case that a random access procedure is initiated by a physical downlink control channel (PDCCH) order for an LTM candidate cell, which is different from a cell to which the terminal performed a last random access preamble transmission for a same cell group, a preamble power counter is to be reset, and
wherein, in case that the random access procedure is initiated by the PDCCH order for the LTM candidate cell, which is different from a cell to which the terminal performed a last random access preamble transmission for a different cell group, the preamble power counter is not to be reset.

13. A base station in a wireless communication system, the base station comprising:
a transceiver; and
a controller coupled with the transceiver and configured to:
transmit, to a terminal, a radio resource control (RRC) reconfiguration message comprising configuration information on a layer 1/layer 2 triggered mobility (LTM) cell switch execution, and
in case that the RRC reconfiguration message is applied due to the LTM cell switch execution and is configured via an LTM configuration (LTM-config) information element (IE) contained in new radio secondary cell group (nr-SCG) IE within a multi radio dual connectivity secondary cell group (mrdc-SecondaryCellGroup) IE, receive, from the terminal, an RRC reconfiguration complete message via a signaling radio bearer 1 (SRB1) embedded in NR RRC message uplink information transfer MRDC (ULInformationTransferMRDC).

14. The base station of claim 13, wherein the controller is further configured to:
in case that the RRC reconfiguration message is not applied due to the LTM cell switch execution configured via the LTM-config contained in the nr-SCG within the mrdc-SecondaryCellGroup, receive, from the terminal, an RRC reconfiguration complete message in a secondary cell group response (SCG-Response) within an master cell group (MCG) RRC reconfiguration complete message.

15. The base station of claim 13, wherein the RRC reconfiguration message is received via the SRB1.

16. The base station of claim 13,
wherein, in case that a random access procedure is initiated by a physical downlink control channel (PDCCH) order for an LTM candidate cell, which is different from a cell to which the terminal performed a last random access preamble transmission for a same cell group, a preamble power counter is to be reset, and
wherein, in case that the random access procedure is initiated by the PDCCH order for the LTM candidate cell, which is different from a cell to which the terminal performed a last random access preamble transmission for a different cell group, the preamble power counter is not to be reset.
